(19) United States
(12) Patent Application Publication
(10) Pub. No.: US 2026/0110809 A1
(43) Pub. Date: Apr. 23, 2026

(54) DETECTION ASSEMBLIES AND METHODS FOR PREPARING CRYSTALS FOR USE IN THE DETECTION ASSEMBLIES

(71) Applicant: SHANGHAI UNITED IMAGING HEALTHCARE CO., LTD., Shanghai (CN)

(72) Inventors: Zhenrui LU, Shanghai (CN); Zhiyong SONG, Shanghai (CN); Zhenjie HAN, Shanghai (CN); Dongdong BI, Shanghai (CN); Jinlin DU, Wuhan (CN); Shaohui AN, Shanghai (CN)

(73) Assignee: SHANGHAI UNITED IMAGING HEALTHCARE CO., LTD., Shanghai (CN)

(21) Appl. No.: 19/363,596

(22) Filed: Oct. 20, 2025

(30) Foreign Application Priority Data
Oct. 18, 2024 (CN) 202411465655.6

(51) Int. Cl. G01T 1/20; G01T 1/202

(52) U.S. Cl. CPC G01T 1/2002; G01T 1/20187; G01T 1/202

(57) ABSTRACT

A detection assembly is provided. The detection assembly includes: at least one crystal including a first end and a second end oppositely disposed along a first direction. A processing unit provided at the first end of the at least one crystal. An optical partition extending along the first direction is provided within each of the at least one crystal, and the optical partition forms two optical channels extending along the first direction within the crystal. Along the first direction, each of the two optical channels includes a first end and a second end opposite to each other, the first ends of the two optical channels correspond to the first end of the at least one crystal, and the second ends of the two optical channels correspond to the second end of the at least one crystal and are optically connected. At least one grating structure is provided in at least one of the two optical channels, and the at least one grating structure is configured to differentiate propagation scintillation photons in the at least one of the two optical channels.

### CROSS-REFERENCE TO RELATED APPLICATIONS

This application claims priority to the Chinese Patent Application No. 202411465655.6, filed on Oct. 18, 2024, the contents of which are hereby incorporated by reference.

### TECHNICAL FIELD

The present disclosure relates to the field of medical technology, and more particularly, to a detection assembly and a method for preparing a crystal for use in the detection assembly.

### BACKGROUND

Positron Emission Tomography (PET), as an advanced imaging technology, plays a pivotal and irreplaceable role in a plurality of fields, including clinical medicine and medical research such as tumor diagnosis, cardiovascular assessment, and drug development. A detection assembly is an important component in a PET imaging system. Its main function is to convert incident γ photons into electrical signals for determining information such as the position, time, and energy of the interaction of the γ photons with the crystal. This information is then used to image an object.

The sensitivity and spatial resolution of the detection assembly in an imaging system are two important indicators affecting imaging quality. However, in PET imaging systems lacking depth of interaction (DOI) capability, there is a constraint between these two key design indicators, making it difficult to achieve both simultaneously. This leads to system designs that must make trade-offs based on the primary application scenario, making it difficult to obtain ideal imaging quality.

### SUMMARY

It is necessary to provide a detection assembly and a method for preparing a crystal for use in the detection assembly in view of the above technical problems.

An aspect of the present disclosure provides a detection assembly. The detection assembly includes: at least one crystal including a first end and a second end oppositely disposed along a first direction. A processing unit provided at the first end of the at least one crystal. An optical partition extending along the first direction is provided within each of the at least one crystal, and the optical partition forms two optical channels extending along the first direction within the crystal. Along the first direction, each of the two optical channels includes a first end and a second end opposite to each other, the first ends of the two optical channels correspond to the first end of the at least one crystal, and the second ends of the two optical channels correspond to the second end of the at least one crystal and are optically connected. At least one grating structure is provided in at least one of the two optical channels, and the at least one grating structure is configured to differentiate propagation of scintillation photons in the at least one of the two optical channels.

An aspect of the present disclosure provides a method for preparing a crystal for use in a detection assembly. The method includes: processing a crystal to be processed to form an optical partition extending along a first direction inside the crystal to be processed. The optical partition forms two optical channels extending along the first direction within the crystal to be processed. The crystal to be processed includes a light incident surface and a light emitting surface oppositely disposed along the first direction. Along the first direction, each of the two optical channels includes a first end and a second end oppositely disposed, the first ends of the two optical channels correspond to the light emitting surface, and the second ends of the two optical channels correspond to the light incident surface and are optically connected. The method further includes: processing the crystal to be processed to form at least one grating structure in at least one of the two optical channels, the at least one grating structure being configured to differentiate propagation of scintillation photons in the at least one of the two optical channels.

An aspect of the present disclosure provides a method for determining photon information. The method is applied to a detection assembly. The detection assembly includes: at least one crystal including a first end and a second end oppositely disposed along a first direction. A processing unit provided at the first end of the at least one crystal. An optical partition extending along the first direction is provided within each of the at least one crystal, and the optical partition forms two optical channels extending along the first direction with the crystal. Along the first direction, each of the two optical channels includes a first end and a second end opposite to each other, the first ends of the two optical channels correspond to the first end of the at least one crystal, and the second ends of the two optical channels correspond to the second end of the at least one crystal and are optically connected. At least one grating structure is provided in at least one of the two optical channels, and the at least one grating structure is configured to differentiate propagation of scintillation photons in the at least one of the two optical channels. The method further includes: obtaining a crystal three-dimensional position lookup table; and determining a three-dimensional position where a scintillation event occurs in the at least one crystal based on photon energy information acquired by the processing unit and the crystal three-dimensional position lookup table.

### BRIEF DESCRIPTION OF THE DRAWINGS

In order to more clearly illustrate the technical solutions in the embodiments of the present disclosure, the accompanying drawings that need to be used in the embodiments will be briefly introduced in the following. It is apparent that the drawings in the following description are merely some embodiments of the present disclosure and should not be construed as any limitation on the present disclosure. For a person of ordinary skill in the art, other embodiments and their corresponding drawings may also be obtained based on these drawings.

FIG. 1 is a schematic diagram illustrating an exemplary structure of a detection assembly according to some embodiments of the present disclosure;

FIG. 2 is a schematic diagram illustrating an exemplary structure of a gap according to some embodiments of the present disclosure;

FIG. 3A is a schematic diagram illustrating an exemplary structure of a partition grating according to some other embodiments of the present disclosure;

FIG. 3B is a schematic diagram illustrating an exemplary structure of a partition grating according to some other embodiments of the present disclosure;

FIG. 4 is a schematic diagram illustrating an exemplary structure of a grating structure according to some embodiments of the present disclosure;

FIG. 5 is a schematic diagram illustrating an exemplary structure of a detection assembly according to other embodiments of the present disclosure;

FIG. 6 is a schematic diagram illustrating an exemplary structure of a grating structure according to other embodiments of the present disclosure;

FIG. 7 is a schematic diagram illustrating an exemplary structure of a detection assembly according to other embodiments of the present disclosure;

FIG. 8 is a schematic diagram illustrating an exemplary distribution of photoelectric devices according to some embodiments of the present disclosure;

FIG. 9 is a schematic diagram illustrating an exemplary distribution of photoelectric devices according to some other embodiments of the present disclosure;

FIG. 10 is a schematic diagram illustrating an exemplary structure of a detection assembly according to other embodiments of the present disclosure;

FIG. 11A and FIG. 11B are schematic comparison diagrams illustrating depth of interaction (DOI) capability without and with a grating structure according to some embodiments of the present disclosure;

FIG. 12 is an exemplary flowchart illustrating an exemplary method for preparing a crystal according to some embodiments of the present disclosure;

FIG. 13 is an exemplary flowchart illustrating an exemplary method for determining photon information according to some embodiments of the present disclosure;

FIG. 14 is a schematic diagram illustrating an exemplary measured result of a two-dimensional array DOI resolution according to some embodiments of the present disclosure;

FIGS. 15 and 16 are schematic diagrams illustrating an exemplary configuration of reflective films in a crystal array according to some embodiments of the present disclosure; and

FIG. 17A and FIG. 17B are schematic diagrams illustrating an exemplary structure of a detection assembly according to some embodiments of the present disclosure.

### DETAILED DESCRIPTION

To more clearly illustrate the objectives, technical solutions, and advantages of the present disclosure, the accompanying drawings to be used in the description of the embodiments will be briefly described below It should be understood that the specific embodiments described herein are merely intended to explain the present disclosure and are not intended to limit the present disclosure.

It should be noted that when an element is referred to as being “fixed to” or “disposed on” another element, it can be directly on the other element or indirectly on the other element. When an element is referred to as being “connected to” another element, it can be directly connected to the other element or indirectly connected to the other element. Furthermore, a connection can be for a fixing function, a coupling function, or a communication function.

It should also be noted that, in this document, relational terms such as first and second are used merely to distinguish one entity or operation from another entity or operation, without necessarily requiring or implying any actual such relationship or order between these entities or operations. Moreover, the terms “include,” “comprise,” or any other variations thereof are intended to cover a non-exclusive inclusion, so that a process, method, article, or device that includes a list of elements includes not only those elements but also other elements not explicitly listed, or elements inherent to such process, method, article, or device. In the absence of more limitations, an element defined by the phrase “includes a . . . ” does not exclude the existence of additional identical or equivalent elements in the process, method, article, or device that includes the element. Furthermore, terms such as “upper,” “lower,” “top,” “bottom,” etc., do not constitute absolute spatial relationship limitations but are relative concepts.

The present disclosure provides systems and components for non-invasive imaging, for example, for disease diagnosis or research purposes. An imaging system can be applied in different fields such as medicine or industry. For example, the imaging system can be used for internal inspection of components, such as one or a combination of defect detection, security scanning, failure analysis, metrology, assembly analysis, void analysis, wall thickness analysis, etc.

To make the objectives, technical solutions, and advantages of the present disclosure clearer, the present disclosure is further described in detail below with reference to the accompanying drawings and embodiments. It should be understood that the specific embodiments described herein are merely intended to explain the present disclosure and are not intended to limit the present disclosure.

Sensitivity and spatial resolution of a detection assembly in an imaging system are two important indicators affecting imaging quality. Sensitivity determines whether the imaging system can detect an imaging object, while spatial resolution determines whether the imaging system can clearly identify the imaging object.

To achieve higher system sensitivity performance, strategies typically adopted in detection assembly design include increasing crystal thickness (a dimension along a main propagation direction of scintillation photons within the crystal) to obtain higher radiation stopping efficiency (e.g., GE DMI uses 25 mm thick crystals), or increasing the system axial dimension (along a long axis direction of the body of a patient, i.e., a direction from the head of the patient to the feet of the patient) to obtain a larger solid angle coverage (e.g., UIH uExplorer uses a 2 m axial length (a physical length of the detection assembly along the long axis direction of the body of the patient)), or pursuing faster time-of-flight (TOF) performance to obtain a higher signal-to-noise ratio thereby improving the system equivalent sensitivity (e.g., UIH Panorama has 192 ps TOF performance).

The spatial resolution has two meanings. The first is the intrinsic spatial resolution limit achievable at a center field of view of the system. Using smaller crystal pixel units helps improve the central resolution performance (e.g., UIH Panorama, which has the highest clinical resolution in the industry, uses 2.76×2.76×18×2 mm³ crystal units). The second is an ability of the system to maintain consistent spatial resolution performance across the full field-of-view (FFOV). Since events near the edge of the system field of view enter the crystal in an oblique incidence form, if depth of actions of these events cannot be effectively distinguished, a parallax effect will occur, causing a resolution capability of the system to rapidly deteriorate from the center to the edge of the field of view, ultimately leading to image distortion and quantitative analysis errors.

However, in the detection assembly design, although thicker crystals and a longer system axial length are beneficial for improving the sensitivity, the parallax effect caused by oblique incidence in the transaxial edge (where the detection assemblies in the imaging system are distributed in a ring array) and the long-axis direction will also correspondingly increase, leading to deterioration of system spatial resolution consistency. Faster TOF typically requires thinner crystals and larger crystal pixel unit designs, which will lead to a reduction in the sensitivity and the spatial resolution. Conversely, using small-size crystals to improve the spatial resolution will strengthen the parallax effect, leading to a reduction in spatial resolution consistency and TOF resolution capability. In conventional positron emission computed tomography (PET) system design, various parameters constrain each other, making it difficult to achieve all simultaneously, resulting in poor image quality obtained by the imaging system based on the detection assembly.

Therefore, the depth of interaction (DOI) capability of the crystal plays an increasingly important role in PET system design. However, due to factors such as hardware cost (dual-end, multi-end, side readout), calibration methods (single-end continuous), and process difficulty (single-end physical multilayer), current mainstream commercial clinical systems do not include DOI-PET systems.

“Single-end” in single-end continuous refers to the crystal in the detection assembly having a photoelectric device (such as a silicon photomultiplier, etc.) installed only at one end. “Continuous” in single-end continuous refers to the output of the light signal changing continuously along the crystal thickness direction (the dimension along the main propagation direction of scintillation photons within the crystal).

Single-end physical multilayer may involve dividing the crystal into a plurality of crystal layers in the crystal thickness direction, and the light signal is received by an photoelectric device at one end of the crystal.

Based on this, the present disclosure provides a detection assembly with a single-end readout structure and having DOI capability. When the detection assembly is applied to an imaging system, it can reduce the parallax effect and take spatial resolution capability into account while pursuing sensitivity, thereby improving the imaging quality of the imaging system.

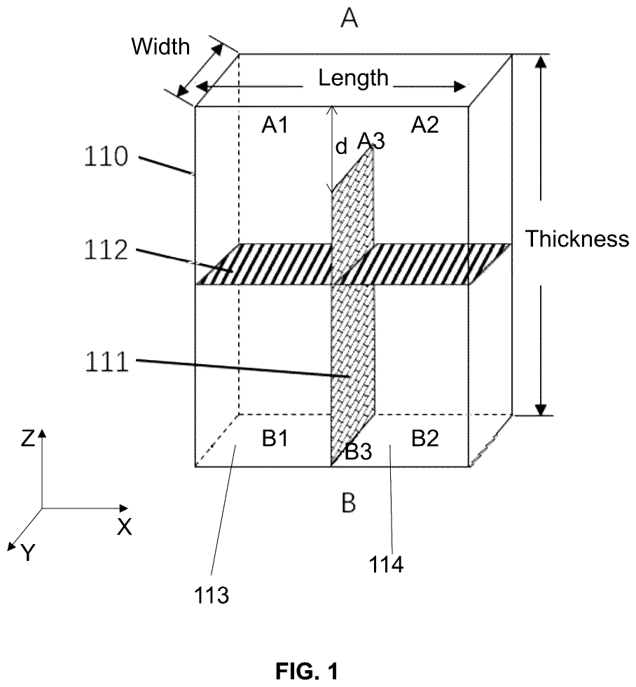

FIG. 1 is a schematic diagram illustrating an exemplary structure of a crystal according to some embodiments of the present disclosure.

In some embodiments, the detection assembly provided in the present disclosure includes at least one crystal and a processing unit.

In some embodiments, the at least one crystal includes a first end and a second end oppositely disposed along a first direction. The processing unit is provided at the first end of the at least one crystal.

The at least one crystal may be a scintillation crystal capable of absorbing high-energy photons (e.g., gamma rays) and emitting scintillation photons (e.g., visible or ultraviolet light). For example, the crystal may include at least one of bismuth germanate (BGO), lutetium orthosilicate (LSO), lutetium yttrium orthosilicate (LYSO), or the like.

Therefore, the crystal may react with incident high-energy photons to produce a group of visible photons. That is, after the incident high-energy photons enter the crystal, a fluorescence effect occurs, generating a light signal. The light signal may be a light wave that uses changes in one or more attributes of the light wave (e.g., intensity and phase) to transmit information.

Merely by way of example, in PET imaging, a radioactive tracer (e.g., ¹⁸F-FDG) releases positrons (β⁺) within an imaging object. The positrons annihilate with surrounding electrons, producing a pair of gamma photons with an energy of 511 keV, which shoot out in opposite directions. When a gamma photon enters the crystal and interacts with the crystal, the crystal absorbs the energy of the gamma photon and transmits the energy to the crystal's atoms. The atoms are elevated to excited states by absorbing the energy. Subsequently, when the excited atoms transition back to their ground state, scintillation photons (also referred to as scintillation light) are generated.

In some embodiments, the crystal has a columnar structure. As an example, as shown in FIG. 1, the crystal has a cuboid shape.

In some embodiments, taking a crystal 110 in FIG. 1 as an example, as shown in FIG. 1, the first direction may be a thickness direction of the crystal or a main propagation direction of scintillation photons. That is, the first direction is a direction from a generation position of the scintillation photons toward the processing unit. The second end may be a light incident surface of the crystal. The first end may be a light emitting surface of the crystal. As an example, the first end of the crystal may be an end B in FIG. 1. The second end of the crystal may be an end A in FIG. 1. The first direction is a direction Z (a thickness direction of the crystal) in FIG. 1.

In some embodiments, an optical partition extending along the first direction is provided within each of the at least one crystal, and the optical partition forms two optical channels extending along the first direction within the crystal.

The optical channel may be an optical conduction path separated by the optical partition inside the crystal. The optical channel is configured to guide the scintillation photons to propagate toward the processing unit.

The optical partition refers to a physical or optical isolation structure provided between the two optical channels. The optical partition is configured to prevent or limit crosstalk of the scintillation photons between the two optical channels.

For example, as shown in FIG. 1, an optical partition 111 is provided in the crystal 110. The optical partition 111 separates the crystal into an inverted “U”-shaped crystal that is continuous at the second end and discontinuous at the first end, forming two optical channels 113 and 114 extending along the first direction.

In some embodiments, the two optical channels are optically connected at the second end of the at least one crystal. Along the the first direction, each of the two optical channels includes a first end and a second end opposite to each other. The first ends of the two optical channels (e.g., B1 and B2 in FIG. 1) correspond to the first end of the at least one crystal, and are optically isolated with each other by the optical partition. The second ends of the two optical channels (e.g., A1 and A2 in FIG. 1) correspond to the second end of the at least one crystal and are optically connected.

In some embodiments, a length of the optical partition provided between the two optical channels along the first direction may be a preset length. The preset length may be preset based on historical experience. For example, the preset length is less than a vertical length from the first end of the crystal to the second end of the crystal.

In some embodiments, a width of the optical partition may be preset. For example, the width of the optical partition is the same as a width of the crystal. As an example, a width direction of the optical partition is a direction Y in FIG. 1. The width of the optical partition in the direction Y is the same as the width of the crystal in the direction Y.

As shown in FIG. 1, the optical partition 111 extends along an extension direction to limit an optical path of the light signal within the crystal.

In some embodiments, the optical partition is parallel to the thickness direction of the crystal (e.g., the direction Z in FIG. 1).

In some embodiments, a ratio of a length of the optical partition along the first direction (i.e., the preset length) to a length of the at least one crystal along the first direction (also referred to as a thickness of the crystal) is in a preset range that is set according to actual demand.

In some embodiments, when the ratio of the preset length to the length of the at least one crystal along the first direction is excessively large, it indicates a high degree of optical isolation between the two optical channels. A change in a signal ratio of the two optical channels relative to depth weakens, resulting in a decrease in the DOI capability. When the ratio of the preset length to the length of the at least one crystal along the first direction is excessively small, severe crosstalk of the scintillation photons occurs between the two optical channels, and a signal-to-noise ratio decreases, thereby leading to a decrease in the DOI capability.

The depth may refer to a degree to which a position where the scintillation photons are generated in the crystal (an interaction position of a gamma photon with the crystal) is close to the first end of the crystal along the first direction, or a degree to which the position is far from the second end of the crystal along the first direction. A greater depth indicates that the position where the scintillation photons are generated in the crystal is closer to the first end of the crystal along the first direction and farther from the second end of the crystal along the first direction.

In some embodiments of the present disclosure, by defining a relationship between the length of the optical partition and a size of the crystal, the optical partitions of different lengths can be designed for crystals of different sizes. This ensures consistency in performance for various crystals and improves universality for different crystals.

In some embodiments, along the first direction, the optical partition includes a first end (e.g., B3 as shown in FIG. 1) corresponding to the first ends of the two optical channels and a second end (e.g., A3 as shown in FIG. 1) corresponding to the second ends of the two optical channels. For example, the first end of the optical partition is close to the first ends of the two optical channels. The second end of the optical partition is close to the second ends of the two optical channels.

In some embodiments, the first ends of the two optical channels are isolated by the optical partition. That is, the first end of the optical partition extends to the light emitting surface of the crystal (e.g., the first end of the crystal and/or the first ends of the optical channels). In some embodiments, along the first direction, the second end of the optical partition and the second end of the crystal (and/or the two optical channels) have a preset distance (e.g., d as shown in FIG. 1), so that the second ends of the two optical channels are optically connected. Merely by way of example, the preset distance is equal to a difference between a dimension of the optical channel (or the crystal) along the first direction and a dimension of the optical partition along the first direction.

In some embodiments of the present disclosure, the first ends of the two optical channels are isolated by the optical partition. This ensures that a light signal received by the processing unit corresponding to a single optical channel originates from that optical channel, thereby preventing any mixing of light signals between the two optical channels.

In some embodiments, the two optical channels are symmetrical with respect to the optical partition. That is, the two optical channels exhibit a mirror-image relationship in shape, size, and layout, forming a symmetrical overall structure. Along the length direction of the crystal (e.g., the direction X in FIG. 1), the optical partition is located at a middle position inside the crystal. In some embodiments, along the length direction of the crystal (e.g., the direction X in FIG. 1), a distance between each optical channel and the optical partition is equal.

In some embodiments, the two optical channels may also be asymmetrical with respect to the optical partition. That is, a distance between each optical channel and the optical partition is not equal.

In some embodiments of the present disclosure, by arranging symmetrical optical channels within the crystal, system errors unrelated to light signals introduced by differences between the two optical channel are reduced. This simplifies the calibration process of the imaging system and makes subsequent determination of photon information more efficient and accurate.

In some embodiments, the optical partition may include at least one of a reflective layer, a gap, or a partition layer.

The gap refers to a physical gap between the two optical channels.

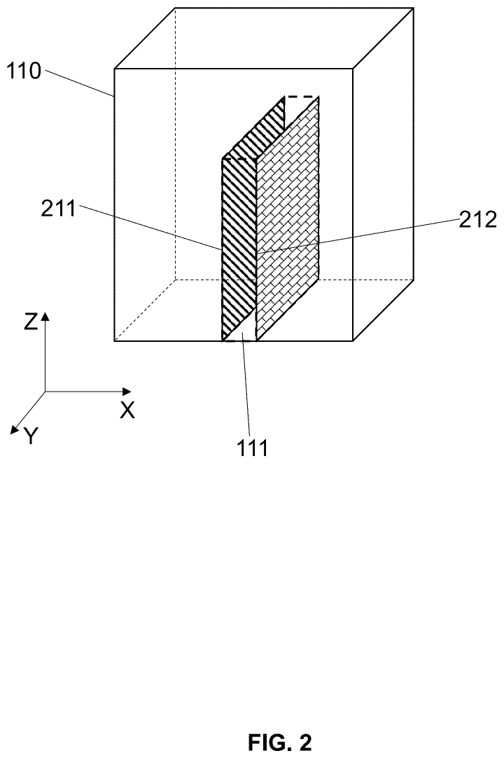

FIG. 2 is a schematic diagram illustrating an exemplary structure of a gap according to some embodiments of the present disclosure. Directions X, Y, and Z shown in FIG. 2 correspond to the directions X, Y, and Z shown in FIG. 1. In some embodiments, after the crystal is mechanically cut or chemically etched, the gap may be formed in the crystal, i.e., a physical gap between the two optical channels. The gap may be filled with air, an inert gas, etc.

In some embodiments, along the X direction, the gap includes two opposite surfaces. The two opposite surfaces are provided with reflective layers or reflective materials. As shown in FIG. 2, the crystal 110 includes a gap 111. Along the X direction, the gap includes two opposite surfaces 211 and 212. The two opposite surfaces 211 and 212 are provided with reflective layers or reflective materials (represented by the shaded regions in FIG. 2).

The reflective layer refers to a layer of reflective material between the two optical channels. The reflective material used for the reflective material layer includes barium sulfate, a metal (e.g., silver), an Enhanced Specular Reflector (ESR), etc.

The partition layer refers to a layer of material between the two optical channels that has light-absorbing or light-scattering properties, such as black anodized aluminum.

In some embodiments, the optical partition may also be constituted by at least one combination of the reflective layer, the gap, the partition layer, etc. As an example, the reflective layer may be evaporated on a wall surface of the physical gap between the two optical channels, forming a composite optical partition.

In some embodiments, the optical partition may include a partition grating.

The partition grating refers to an optical grating that acts as an optical partition. The partition grating may include light-transmitting regions and light blocking regions arranged at intervals along the first direction. A dimension of the light-transmitting regions and the light blocking regions along the direction Y is equal to a dimension of the crystal along the direction Y (width). More description regarding the partition grating may be found in the following text and its related descriptions.

In some embodiments, the optical partition may also be obtained by stacking at least two partition gratings along the direction X. For two adjacent partition gratings, along the first direction, a position of a light-transmitting region of one partition grating corresponds to a light blocking region of the other partition grating.

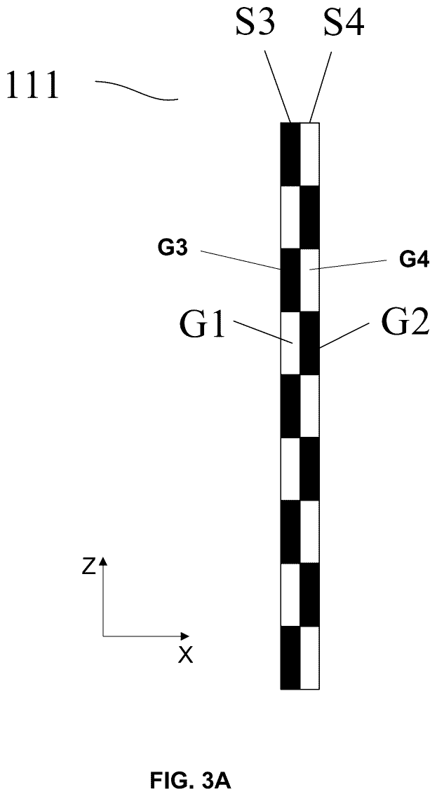

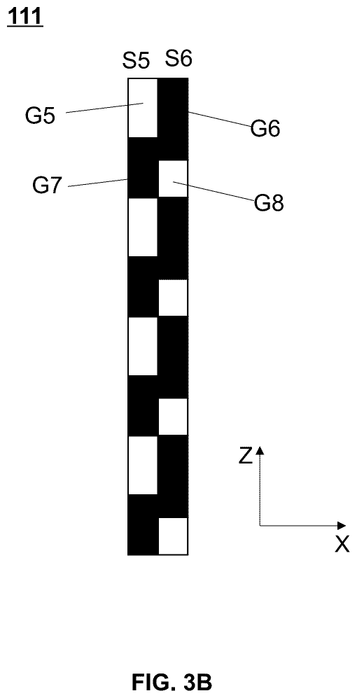

FIG. 3A is a schematic diagram illustrating an exemplary structure of a partition grating according to some other embodiments of the present disclosure. FIG. 3B is a schematic diagram illustrating an exemplary structure of a partition grating according to some other embodiments of the present disclosure. Directions X and Z shown in FIG. 3A and FIG. 3B correspond to the directions X and Z shown in FIG. 1.

For example, as shown in FIG. 3A, a partition grating S3 and a partition grating S4 are stacked along the direction X to form the optical partition 111. Along the first direction, a position of a light-transmitting region of the partition grating S3 (white blocks in S3) corresponds to a position of a light blocking region of the partition grating S4 (black blocks in S4) (e.g., a position of a light-transmitting region G1 of S3 corresponds to a position of a light blocking region G2 of S4); and a position of a light blocking region of the partition grating S3 (black blocks in S3) corresponds to a position of a light-transmitting region of the partition grating S4 (white blocks in S4) (e.g., a position of a light-transmitting region G4 of S4 corresponds to a position of a light blocking region G3 of S3).

As shown in FIG. 3B, a partition grating S5 and a partition grating S6 are stacked along the direction X to form the optical partition 111. Along the first direction, a position of a light-transmitting region of the partition grating S5 (white blocks in S5) partially overlaps a position of a light blocking region of the partition grating S6 (black blocks in S6) (e.g., a position of a light-transmitting region G5 of S5 partially overlaps a position of a light blocking region G6 of S6); and a position of a light blocking region of the partition grating S5 (black blocks in S5) corresponds to a position of a light-transmitting region of the partition grating S6 (white blocks in S6) (e.g., a position of a light-transmitting region G8 of S6 corresponds to a position of a light blocking region G7 of S5).

Specifically, in the optical partition, along the direction X, a region in a second partition grating adjacent to a light-transmitting region of a first partition grating is a light blocking region. A dimension of the light blocking region of the second partition grating along the first direction is greater than or equal to a dimension of the light-transmitting region of the first partition grating. For example, a projection of the light blocking region of the second partition grating along the second direction onto the light-transmitting region of the first partition grating completely covers the light-transmitting region of the first partition grating. Along the direction X, a region in the first partition grating adjacent to a light-transmitting region of the second partition grating is a light blocking region. A dimension of the light blocking region of the first partition grating along the first direction is greater than or equal to a dimension of the light-transmitting region of the second partition grating. For example, a projection of the light blocking region of the first partition grating along the second direction onto the light-transmitting region of the second partition grating completely covers the light-transmitting region of the second partition grating.

For example, as shown in FIG. 3A, a region in the partition grating S4 adjacent to the light-transmitting region G1 of the partition grating S3 is the light blocking region G2, and a dimension of the light blocking region G2 along the first direction is equal to a dimension of the light-transmitting region G1. For example, a projection of the light blocking region G2 along the second direction onto the light-transmitting region G1 completely covers the light-transmitting region G1. Along the direction X, a region in the partition grating S3 adjacent to the light-transmitting region G4 of the partition grating S4 is the light blocking region G3, and a dimension of the light blocking region G3 along the first direction is equal to a dimension of the light-transmitting region G4 of the partition grating S4. For example, a projection of the light blocking region G3 along the second direction onto the light-transmitting region G4 completely covers the light-transmitting region G4.

As another example, as shown in FIG. 3B, a region in the partition grating S6 adjacent to the light-transmitting region G5 of the partition grating S5 is the light blocking region G6, and a dimension of the light blocking region G6 along the first direction is greater than a dimension of the light-transmitting region G5. For example, a projection of the light blocking region G6 along the second direction onto the light-transmitting region G5 completely covers the light-transmitting region G5. Along the direction X, a region in the partition grating S5 adjacent to the light-transmitting region G8 of the partition grating S6 is the light blocking region G7, and a dimension of the light blocking region G7 along the first direction is equal to a dimension of the light-transmitting region G8. For example, a projection of the light blocking region G7 along the second direction onto the light-transmitting region G8 completely covers the light-transmitting region G8.

FIG. 3A and FIG. 3B illustrate examples in which two partition gratings are stacked along the direction X. It should be understood that the optical partition may also be formed by stacking more than two partition gratings along the direction X, which is not limited in the present disclosure.

In some embodiments of the present disclosure, separation of the two optical channels may be easily achieved by the optical partition.

In some embodiments, at least one grating structure is provided in at least one of the two optical channels, and the at least one grating structure is configured to differentiate the propagation of the scintillation photons in the at least one of the two optical channels, e.g., allow a portion of the scintillation photons to pass through the at least one grating structure and prevent another portion of the scintillation photons from passing through the at least one grating structure.

The grating structure includes a microstructure provided inside a crystal, and is configured to differentiate propagation of scintillation photons in the at least one of the two optical channels. The microstructure refers to a micron-scale or nano-scale modified point or defect cluster formed inside a crystal after interaction between a laser and the crystal.

In some embodiments, the grating structure includes a light-transmitting region and a light blocking region arranged at intervals and periodically along the direction X.

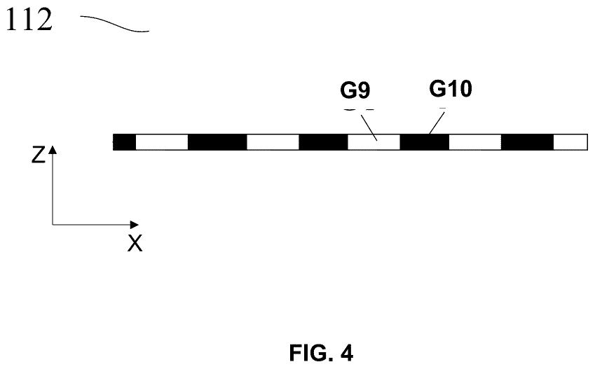

FIG. 4 is a schematic diagram illustrating an exemplary structure of a grating structure according to some embodiments of the present disclosure. Directions X and Z shown in FIG. 4 correspond to the directions X and Z shown in FIG. 1.

Merely by way of example, as shown in FIG. 4, a grating structure 112 includes light-transmitting regions (white blocks in FIG. 4) and light blocking regions (black blocks in FIG. 4) arranged at intervals along the direction X, such as light-transmitting regions G9 and light blocking regions G10 arranged at intervals along the direction X.

In some embodiments, an area of the grating structure 112 in an X-Y plane may be equal to an area of the crystal in the X-Y plane, i.e., a dimension of the grating structure 112 along the direction X is equal to a dimension of the crystal along the direction X, and a dimension of the grating structure 112 along the direction Y is equal to a dimension of the crystal along the direction Y.

Scintillation photons (also referred to as scintillation light) generated at different depth positions have different propagation effects due to different geometric paths when encountering the grating structure, thereby forming depth-related differentiated signals with a higher signal-to-noise ratio at the processing unit, so that depth information can be parsed based on the differentiated signals.

In some embodiments, the grating structure may be formed by arranging a plurality of parallel, equally spaced regular structures along the direction X. For example, the grating structure may be formed by a plurality of protruding strips (e.g., grooves of a reflection grating) arranged at intervals, where the protruding strips constitute the light blocking regions, and the intervals between the protruding strips constitute the light-transmitting regions. As another example, a grating structure may be formed by light-transmitting strips and light blocking strips arranged at intervals, where the light-transmitting strips constitute the light-transmitting regions, and the light blocking strips constitute the light blocking regions.

Differentiating propagation of scintillation photons in the at least one of the two optical channels may be a process in which the grating structure changes a path or energy spatial distribution of the scintillation photons propagating in the optical channel.

It should be understood that when a large count of the scintillation photons are incident on the grating structure, a portion of the scintillation photons pass through the grating structure via the light-transmitting regions of the grating structure, and another portion of the scintillation photons are incident on the light blocking region of the grating structure. Due to the difference in refractive indices among different media, the scintillation light is reflected or refracted by the light blocking regions of the grating structure, thereby dispersing the scintillation photons incident on the grating structure. A light-transmitting direction of the at least one grating structure is related to the first direction. As shown in FIG. 1, a grating structure disposed in an optical channel divides, along the first direction, the optical channel into a first channel portion close to the first end of the crystal and a second channel portion close to the second end of the crystal. The light-transmitting direction of a grating structure being related to the first direction indicates that if a scintillation light from the second channel portion enters the light-transmitting region of grating structure, the grating structure allows the scintillation light from the second channel portion to pass through the grating structure and enter the first channel portion of the grating structure.

In some embodiments, the at least one grating structure is distributed within a coverage range of the optical partition along the first direction, and the light-transmitting direction of the at least one grating structure is related to the first direction.

The coverage range of the optical partition along the first direction may be a spatial region occupied by an entity structure of the optical partition in the first direction. For example, the coverage range of the optical partition along the first direction may be a spatial region from the first end to the second end of the optical partition along the first direction.

In some embodiments of the present disclosure, by providing a portion of grating structures within the coverage range of the optical partition, interference from adjacent optical channels can be avoided when scintillation photons within the range interact with the grating structures, making signals more reliable. At the same time, by setting the light-transmitting direction to be related to the first direction, the grating structure can have a higher control efficiency for the scintillation photons, generating a more significant depth-related response, thereby improving resolution and measurement accuracy of depth information, reducing useless scattering or absorption of the scintillation photons, allowing more scintillation photons to be effectively guided to the processing unit, and thus improving a signal-to-noise ratio of a light signal.

In some embodiments, within the coverage range of the optical partition along the first direction, a count of the at least one grating structure is more than one, and each of the two optical channels is provided with at least one of the more than one grating structure.

In some embodiments, positions of the one or more grating structures respectively provided in the two optical channels may be symmetrically or asymmetrically designed relative to the optical partition. Parameters of the one or more grating structures in each optical channel may also be individually adjusted, that is, the parameters of the grating structures in the crystal may be the same or different. The parameters of the grating structure include a transmittance and a periodicity.

The transmittance is used to characterize a ratio of scintillation photons capable of passing through the grating structure to a total count of scintillation photons incident on the grating structure.

The periodicity is used to characterize a period at which a light-transmitting region and a light blocking region in a grating structure repeatedly appear in space. In some embodiments, the periodicity may be represented by a sum of dimensions, along the direction X, of a single light-transmitting region and a single light blocking region adjacent to the light-transmitting region in the grating structure.

In some embodiments of the present disclosure, by respectively providing the one or more grating structures in the two optical channels and individually adjusting the parameters of the grating structures, scintillation photon propagation behavior within the two optical channels can be independently and efficiently fine-tuned to maximize encoding efficiency and accuracy of depth information.

In some embodiments, within the coverage range of the optical partition along the first direction, counts of the grating structures provided in the two optical channels are the same.

In some embodiments, a height position along the first direction of the one or more grating structures provided in one optical channel corresponds to a height position along the first direction of the one or more grating structures provided in the other optical channel, i.e., positions of the grating structures in the two optical channels along the first direction are symmetrical about the optical partition.

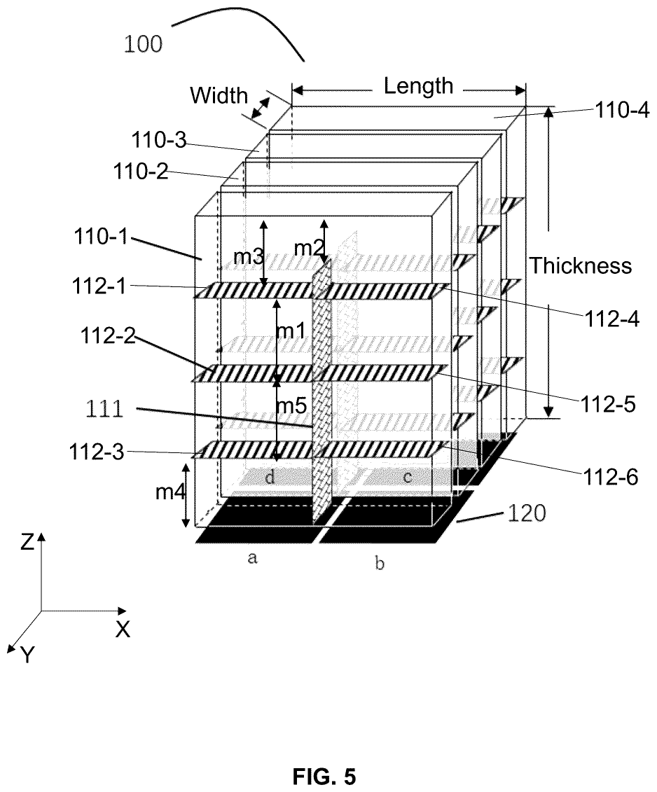

Merely by way of example, as shown in FIG. 5, in the crystal 110, three grating structures (a grating structure 112-1, a grating structure 112-2, and a grating structure 112-3) are sequentially arranged along the direction Z in the left optical channel, and three grating structures (a grating structure 112-4, a grating structure 112-5, and a grating structure 112-6) are sequentially arranged along the direction Z in the right optical channel. The three grating structures in the right optical channel may have identical height positions along the direction Z as the three grating structures in the left optical channel, respectively. For example, the grating structure 112-1 and the grating structure 112-4 have identical height positions along the direction Z, the grating structure 112-2 and the grating structure 112-5 have identical height positions along the direction Z, and the grating structure 112-3 and the grating structure 112-6 have identical height positions along the direction Z. Directions X, Y, and Z in FIG. 5 correspond to the directions X, Y, and Z in FIG. 1.

In some embodiments of the present disclosure, by designing positions of the grating structures in the two optical channels symmetrically about the optical partition, signal differences output by the two optical channels can more purely reflect a depth position of a scintillation event, maximally eliminating additional interference factors caused by differences in position or quantity of the grating structures, thereby facilitating initial calibration and subsequent calculations more simply, and also reducing difficulty in crystal manufacturing.

In some embodiments, along the first direction, a minimum distance between two adjacent grating structures is set according to actual demand. For example, along the first direction, at least two grating structures are provided. Each two adjacent grating structures form a group. Each group of grating structures corresponds to an interval distance along the first direction between the two adjacent grating structures. The minimum distance along the first direction between adjacent grating structures along the first direction is a smallest interval distance among the interval distances of the at least one group of grating structures.

FIG. 5 is a schematic diagram illustrating an exemplary structure of a detection assembly according to other embodiments of the present disclosure.

Merely by way of example, as shown in FIG. 5, grating structures 112-1 to 112-3 are provided in the optical channel along the first direction. An interval distance along the first direction between grating structure 112-1 and grating structure 112-2 is m1. An interval distance along the first direction between grating structure 112-2 and grating structure 112-3 is m5. If m1 is less than m5, the minimum distance along the first direction between adjacent grating structures along the first direction is m1, and a range of m1 is set according to actual demand.

In some embodiments, a range of the minimum distance may be determined by establishing a crystal model in optical simulation software. For example, an initial crystal model is established in the optical simulation software. By adjusting an interval along the first direction between adjacent grating structures along the first direction in the initial crystal model, a plurality of crystal models are obtained. A range covered by intervals corresponding to one or more crystal models that satisfy a preset requirement is determined as the range of the minimum distance.

A crystal model refers to a digital three-dimensional model created in optical simulation software for representing a crystal. The crystal model may characterize geometric structure and optical parameters of an actual crystal. A structure of the crystal model is similar to a structure of the actual crystal, for example, including at least one grating structure.

The optical simulation software is used to simulate propagation of scintillation photons in the crystal model. In some embodiments, the optical simulation software includes Geant4, SPE, etc.

In some embodiments, the optical simulation software may simulate a high-energy photon (e.g., a gamma photon) striking the crystal model, generating a group of visible photons within the crystal model, and track a propagation path of each visible photon (e.g., a scintillation photon).

In some embodiments, the preset requirement may include the spatial resolution, a count of DOI layers, manufacturing process limitations, etc.

The count of DOI layers may be a count of virtual layers obtained by segmenting the crystal along the first direction into a plurality of virtual layers for achieving DOI.

In some embodiments, the manufacturing process limitations may include a minimum distance along the first direction between adjacent grating structures along the first direction that the manufacturing process may produce.

In some embodiments of the present disclosure, by simulating the crystal structure, the minimum distance along the first direction between adjacent grating structures along the first direction may be determined simply, which is beneficial for improving manufacturing efficiency of the crystal.

In some embodiments, a difference between a first distance and a second distance is set according to actual demand, the first distance refers to a distance, along the first direction, between the second end of the at least one crystal and the grating structure closest to the second end of the at least one crystal, e.g., a distance between the second ends of the two optical channels and the grating structure closest to the second ends of the two optical channels within the coverage range, and the second distance refers to a minimum distance, along the first direction, between the optical partition and the second end of the at least one crystal, e.g., a distance between the second end of the optical partition and the second ends of the two optical channels.

Merely by way of example, as shown in FIG. 5, within the coverage range of the optical partition along the first direction, a first distance from a grating structure closest to the second ends of the two optical channels to the second ends of the two optical channels is denoted as m3, and a second distance from the second end of the optical partition to the second ends of the two optical channels is denoted as m2. A difference between m3 and m2 is in a range that is set according to actual demand.

In some embodiments, along the first direction, a minimum distance between the at least one grating structure and the first ends of the two optical channels is set according to actual demand.

Merely by way of example, as shown in FIG. 5, along the first direction, the minimum distance between the at least one grating structure and the first end of the optical channel is denoted as m4, and a range of m4 is set according to actual demand.

In some embodiments, one of the at least one grating structure includes a first grating layer and a second grating layer stacked along the first direction, and a light-transmitting region of the first grating layer and a light-transmitting region of the second grating layer partially overlap. A scintillation photon may pass through the grating structure via an overlapping portion of the light-transmitting region of the first grating layer and the light-transmitting region of the second grating layer, i.e., the overlapping portion of the light-transmitting region of the first grating layer and the light-transmitting region of the second grating layer constitutes a light-transmitting region of the entire grating structure.

In some embodiments, partially overlapping may refer to a vertical projection of the light-transmitting region of the first grating layer along the first direction onto the second grating layer partially overlapping the light-transmitting region on the second grating layer.

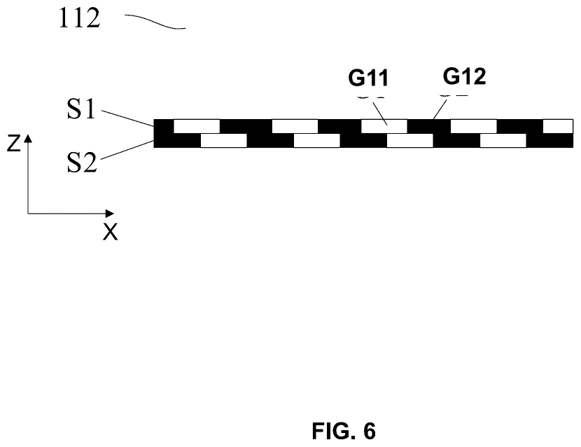

FIG. 6 is a schematic diagram illustrating an exemplary structure of a grating structure according to other embodiments of the present disclosure. Directions X and Z shown in FIG. 6 correspond to the directions X and Z shown in FIG. 1.

Merely by way of example, as shown in FIG. 6, black blocks represent light blocking regions (e.g., G12), and white blocks represent light-transmitting regions (e.g., G11). The grating structure 112 may comprise a first grating layer S1 and a second grating layer S2 stacked along the first direction. A light-transmitting region of the first grating layer S1 and a light-transmitting region of the second grating layer S2 partially overlap.

In some embodiments of the present disclosure, when a crystal manufacturing process cannot fabricate a grating structure with a smaller light-transmitting region, a smaller light-transmitting region can be achieved by misaligning and stacking two grating planes, thereby increasing the modulation range of a light signal. Simultaneously, by adjusting the misalignment amount of the light-transmitting regions of the two grating planes, the effective light transmittance and angular response characteristics of the grating structure can be continuously and precisely adjusted, thus enabling control of optical characteristics.

The processing unit refers to a functional unit where scintillation photons are ultimately detected and processed. In some embodiments, the processing unit is provided with aphotoelectric device.

The photoelectric device refers to an optical sensor or vacuum device capable of converting incident scintillation photons into electrical signals (current or voltage signals). In some embodiments, the optical sensor may include a photomultiplier tube (PMT), a silicon photomultiplier (SiPM), or the like.

In some embodiments, the processing unit includes at least two photoelectric devices, and the at least two photoelectric devices are distributed, along the second direction, on both sides of the optical partition, and the second direction is at a first preset angle with (e.g., perpendicular to) the optical partition.

In some embodiments, the second direction being perpendicular to the optical partition means that the second direction is perpendicular to an extension plane of the optical partition, i.e., the second direction is parallel to a length direction in FIG. 1 (e.g., the direction X in FIG. 2).

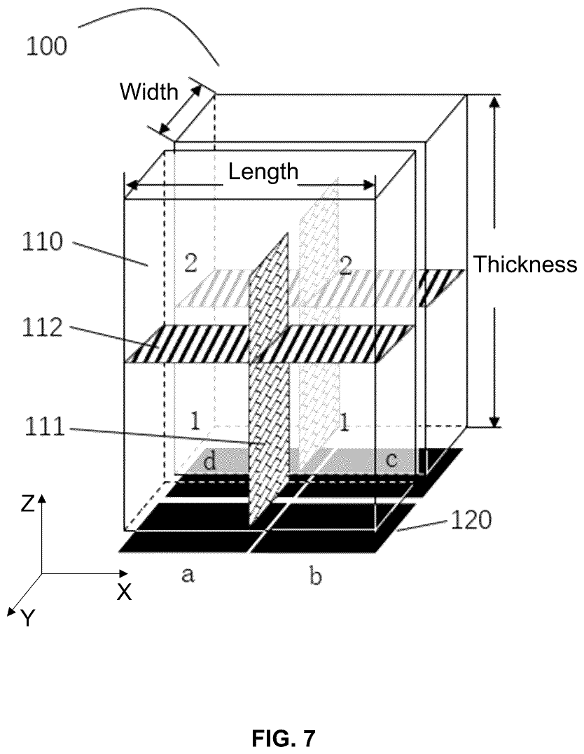

FIG. 7 is a schematic diagram illustrating an exemplary structure of a detection assembly according to other embodiments of the present disclosure. Directions X, Y, and Z shown in FIG. 7 correspond to the directions X, Y, and Z shown in FIG. 1.

Merely by way of example, as shown in FIG. 7, two photoelectric devices a and b are distributed on both sides of the optical partition 111 along the second direction.

In some embodiments, since the first end of the crystal is divided by the optical partition into two (or more) independent light emitting surfaces along the second direction, the at least two photoelectric devices may also be distributed on both sides of the optical partition along the second direction, and are directly coupled or indirectly coupled via a light guide to the two independent light emitting surfaces, i.e., one photoelectric device corresponds to one optical channel.

In some embodiments, when the photoelectric device is directly coupled to the light emitting surface, an area of the photoelectric device is the same as an area of the light emitting surface. When the photoelectric device is indirectly coupled to the light emitting surface via a light guide, the area of the photoelectric device may be smaller than the area of the light emitting surface.

In some embodiments of the present disclosure, a single photoelectric device corresponds to a light emitting surface of one optical channel. This not only achieves maximum light collection efficiency but also ensures independent and interference-free collection and conversion of light signals.

In some embodiments, the detection assembly incudes a plurality of crystals. The plurality of crystals are arranged in a manner that their axes along the direction Z are parallel to each other, along a row direction (e.g., the second direction and the direction X in FIG. 1) and a column direction (e.g., the third direction and the direction Y in FIG. 2), to form a plurality of crystal rows and a plurality of crystal columns, thereby forming a crystal array (a pixel array). The crystals in each crystal row are arranged along the row direction. The crystals in each crystal column are arranged along the column direction. In some embodiments, the third direction is at a second preset angle with (e.g., perpendicular to) the first direction and parallel to the optical partition, for example, as the direction Y in FIG. 1.

In some embodiments, at least a portion of the plurality of crystals is arranged along the second direction, forming a one-dimensional linear array or a row in the crystal array. In this case, each optical channel of each crystal may correspond to one photoelectric device, and a coupling ratio between a count of optical channels and a count of photoelectric devices is 1:1 (e.g., as shown in FIG. 7 and FIG. 8).

FIG. 8 is a schematic diagram illustrating an exemplary distribution of photoelectric devices according to some embodiments of the present disclosure. Directions X and Y shown in FIG. 8 correspond to the directions X and Y shown in FIG. 1. The direction X shown in FIG. 8 is the second direction.

Merely by way of example, as shown in FIG. 8, photoelectric devices S1-S4 are represented by black dashed boxes. For example, an optical partition 111-1 is provided in a crystal A, forming optical channels 113-1 and 114-1 within the crystal A. An optical partition 111-2 is provided in a crystal B, forming optical channels 113-2 and 114-2 within the crystal B. Each optical channel is coupled to one photoelectric device (e.g., a light emitting surface of each optical channel is covered by one photoelectric device). For example, as shown in FIG. 8, the light emitting surface of the optical channel 113-1 is covered by the photoelectric device S1, the light emitting surface of the optical channel 114-1 is covered by the photoelectric device S2, the light emitting surface of the optical channel 113-2 is covered by the photoelectric device S3, and the light emitting surface of the optical channel 114-2 is covered by the photoelectric device S4.

Similarly, at least a portion of the plurality of crystals is arranged along the direction Y, forming a one-dimensional linear array or a column in the crystal array. In this case, each optical channel of each crystal may correspond to one photoelectric device, and a coupling ratio between a count of optical channels and a count of photoelectric devices is 1:1. Similarly, in the crystal array, each optical channel of each crystal may correspond to one photoelectric device, and a coupling ratio between a count of optical channels and a count of photoelectric devices is 1:1.

In some embodiments of the present disclosure, increasing the count of crystals can improve spatial resolution. Simultaneously, designing directional consistency among a crystal arrangement direction, a separation direction (the second direction) of the optical channels, and an arrangement direction of the photoelectric devices simplifies the complexity of alignment, coupling, and data interpretation.

An aperture of the imaging system may be an aperture of a ring array formed by the detection assembly in the imaging system.

In some embodiments, for an imaging system with a large aperture, such as a clinical system, the spatial resolution of the imaging system has a physical limit due to physical factors including a positron free path and nonlinearity of positron-electron annihilation. The imaging quality can be further optimized by improving sensitivity. Therefore, the aforementioned detection assembly with a coupling ratio of 1:1 between the count of optical channels and the count of photoelectric devices can be adopted. A coupling ratio of 1:1 indicates that a length and a width of a single crystal are relatively large, and a filling ratio of reflective films between crystals is relatively low, which can improve the sensitivity of the detection assembly. Meanwhile, with the DOI enhancement brought by the grating structure and the optical partition, the spatial resolution of the detection assembly is not compromised by the larger crystal thickness. This achieves improved sensitivity without affecting spatial resolution, thereby correspondingly improving imaging quality.

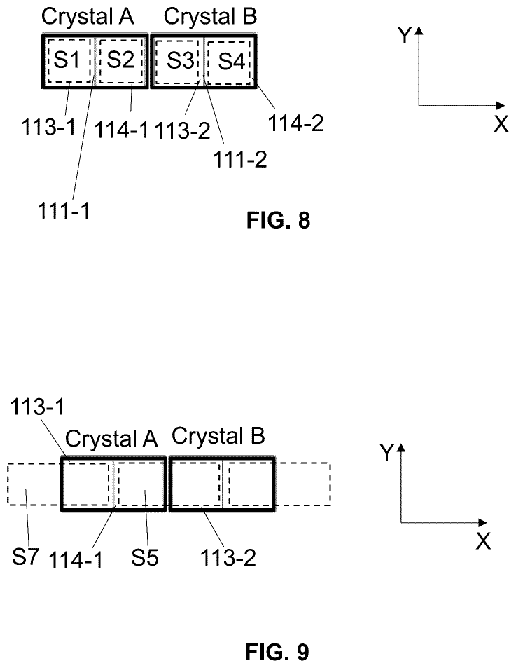

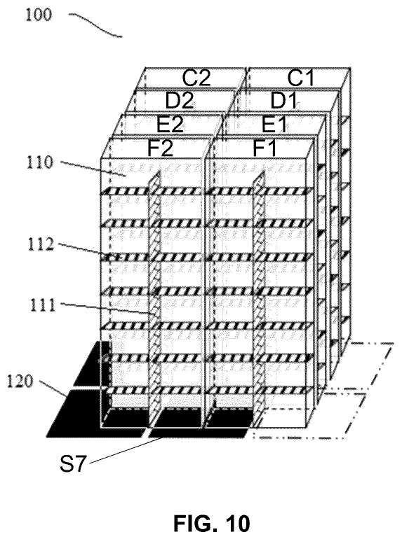

In some embodiments, each of the at least two photoelectric devices covers, along the second direction, two optical channels belonging to different crystals. In this case, one photoelectric device is coupled to two adjacent crystals and receives signals from the two optical channels belonging to the adjacent crystals respectively. The coupling ratio between the count of optical channels and the count of photoelectric devices is 2:1. For example, one photoelectric device covers, along the second direction, light emitting surfaces of optical channels that are adjacent and respectively belong to two adjacent crystals. Additionally, in this scenario, two optical channels of one crystal are coupled to two photoelectric devices respectively (e.g., the light emitting surfaces of the two optical channels of one crystal are covered by two photoelectric devices respectively). In this embodiment, as shown in FIG. 9 and FIG. 10, one photoelectric device may be coupled to (e.g., cover) one or more optical channels (belonging to different crystals) along a third direction (e.g., the direction Y).

FIG. 9 is a schematic diagram illustrating an exemplary distribution of photoelectric devices according to some other embodiments of the present disclosure. Directions X and Y shown in FIG. 9 correspond to the directions X and Y shown in FIG. 1. The direction X shown in FIG. 9 is the second direction. Structures of the crystal A and the crystal B shown in FIG. 9 are similar to structures of the crystal A and the crystal B shown in FIG. 8, and are not described again.

Merely by way of example, as shown in FIG. 9, the photoelectric devices are represented by black dashed boxes. For example, a photoelectric device S5 covers, along the second direction, the right optical channel 114-1 of the crystal A and the left optical channel 113-2 of the crystal B. Additionally, as shown in FIG. 9, the two optical channels 113-1 and 114-1 of the crystal A are coupled to photoelectric devices S7 and S5, respectively. For example, the light emitting surface of the optical channel 113-1 is covered by the photoelectric device S7, and the light emitting surface of the optical channel 114-1 is covered by the photoelectric device S5.

In some embodiments of the present disclosure, by using a photoelectric device with a larger area to receive light signals from the optical channels of two crystals, the cost of using the photoelectric devices is reduced, and the resolution of the light signals in the second direction is improved.

For imaging systems with a small aperture, such as clinical local dedicated systems or preclinical large animal systems, to improve imaging quality, it is necessary to further enhance the spatial resolution capability of the detection assembly. Therefore, the photoelectric device with a larger area is used, resulting in the coupling ratio of 2:1 between the count of optical channels and the count of photoelectric devices, to obtain better spatial resolution performance.

In some embodiments, at least a portion of the plurality of crystals is arranged along the third direction (e.g., the direction Y), forming a one-dimensional linear array or a column in the crystal array.

In some embodiments, each photoelectric device covers a plurality of optical channels along the third direction. In this case, one photoelectric device is coupled to a plurality of optical channels on the same side of the plurality of crystals adjacent along the third direction, and receives signals from the plurality of optical channels on the same side of the plurality of crystals adjacent along the third direction (e.g., as shown in FIG. 5 and FIG. 10). The coupling ratio between the count of optical channels and the count of photoelectric devices may be greater than or equal to 2:1. For example, one photoelectric device covers light emitting surfaces of the plurality of optical channels on the same side of the plurality of crystals adjacent along the third direction. In this embodiment, along the second direction, one photoelectric device may be coupled to (e.g., cover) one optical channel or two optical channels (e.g., as shown in FIG. 10) belonging to different crystals (e.g., two adjacent optical channels belonging to two adjacent crystals, respectively).

FIG. 10 is a schematic diagram illustrating an exemplary structure of a detection assembly according to other embodiments of the present disclosure. Directions X, Y, and, Z shown in FIG. 10 correspond to the directions X, Y, and, Z shown in FIG. 1. The direction X shown in FIG. 10 is the second direction, and the direction Y in FIG. 10 is the third direction. FIG. 10 shows 8 crystals C1-F1 and C2-F2 arranged in two columns and four rows along the second direction and the third direction. The structure of the crystals shown in FIG. 10 is similar to the structure of crystal A and crystal B shown in FIG. 8, and is not described again.

Merely by way of example, as shown in FIG. 10, a photoelectric device S7 is represented by a black box. The photoelectric device S7 covers light emitting surfaces of optical channels on the right side of crystals E2 and F2, and light emitting surfaces of optical channels on the left side of crystals E1 and F1. That is, the entire covering range of the photoelectric device S7 is 4 optical channels; wherein the covering range, along the third direction, of the photoelectric device S7 is 2 optical channels that belong to different crystals in the same column; and the covering range, along the second direction, of the photoelectric device S7 is two adjacent optical channels that respectively belong to two adjacent crystals. The coupling ratio between the count of optical channels and the count of photoelectric devices is 4:1.

FIG. 5 is a schematic diagram illustrating an exemplary distribution of photoelectric devices according to some other embodiments of the present disclosure. Directions X, Y, and Z shown in FIG. 5 correspond to the directions X, Y, and Z shown in FIG. 1. The direction X shown in FIG. 5 is the second direction, and the direction Y in FIG. 5 is the third direction. FIG. 5 shows 4 crystals 110-1 to 110-4 arranged in one column along the third direction.

Merely by way of example, as shown in FIG. 5, photoelectric devices a-d are represented by black boxes. Taking the photoelectric device a as an example, the photoelectric device a covers light emitting surfaces of optical channels on the right side of crystals 110-1 and 110-2 along the third direction. That is, the entire covering range of the photoelectric device a is 2 optical channels; wherein the covering range, along the third direction, of the photoelectric device a is 2 optical channels that belong to different crystals in the same column; and the covering range, along the second direction, of the photoelectric device a is one optical channel. The coupling ratio between the count of optical channels and the count of photoelectric devices is 2:1.

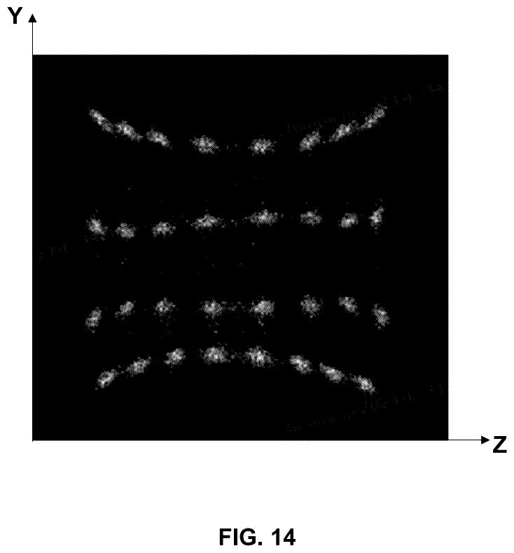

FIG. 14 shows a measured result of a two-dimensional array discrete DOI of the scintillation crystal array as shown in FIG. 5. Each crystal position and each layer of DOI have extremely high separation degree, which can achieve precise positioning of the incident photon response.

In some embodiments of the present disclosure, by increasing the multiplexing of the photoelectric devices in the third direction, the count of the photoelectric devices used is reduced.

For imaging systems with an even smaller aperture, such as small animal systems, to improve imaging quality, it is necessary to further enhance the spatial resolution capability. Therefore, increasing the multiplexing of the photoelectric devices in the third direction, so that the coupling ratio between the count of optical channels and the count of photoelectric devices is greater than 2:1, further enhances the spatial resolution capability.

In some embodiments of the present disclosure, by using the optical partition to make the crystal have the inverted “U” shape, a single-end readout of the crystal can be achieved, reducing the complexity and cost of the imaging system. Simultaneously, through the grating structure and the dual optical channel design, the imaging system can effectively distinguish signals generated by scintillation photons at different depths, significantly reduce the parallax effect, and improve the consistency of spatial resolution.

As described above, the detection assembly includes at least one crystal and a processing unit coupled to the light emitting surface of the at least one crystal. A plurality of detection assemblies form a detector ring of a PET imaging device around the same axis. The thickness direction of the crystal is along a radial direction of the detector ring. The width direction (or length direction) of the crystal is along an axial direction of the detector ring. The length direction (or width direction) of the crystal is along a circumferential direction of the detector ring. Along the radial direction of the detector ring, the second end (the light incident surface) of the crystal is located on an inner side of the detector ring (closer to the axis of the detector ring), and the first end (the light emitting surface) of the crystal and the processing unit are located on an outer side of the detector ring (farther from the axis of the detector ring).

Merely by way of example, taking the application of the detection assembly 100 in a Positron Emission Tomography (PET) system as an example, and with reference to FIG. 7, the working process of the detection assembly 100 is generally as follows.

During a PET scan, a positron emitted by a radionuclide injected into an object to be scanned annihilates with an electron within the object to be scanned, thereby emitting a pair of high-energy photons (e.g., γ photons) with opposite directions and equal energy to enter the crystal 110 in the detection assembly 100. The γ photons interact with the crystal 110 to produce scintillation photons. The scintillation photons are effectively collected by reflection surfaces in the crystal 110, and are reflected and refracted by the grating structure 112, transmitting along the inverted “U”-shaped channel formed by the optical partition 111 toward the two light emitting surfaces. Then, the photoelectric device 120 converts the light signals formed by the output scintillation photons into electrical signals and outputs the electrical signals.

A main function of the detection assembly 100 is to obtain a position where the scintillation photons are generated (e.g., a position where the gamma photon interact with the crystal) in the crystal 110, deposited energy, and a time point of the interaction. The grating structure 112 in the crystal 110 forms physical layers inside the crystal 110. Scintillation photons interact in different physical layers to form light signals. Optical paths of the light signals formed in the different physical layers are jointly influenced by the grating structure 112 and the optical partition 111, causing the finally output light signals to exhibit differences. This enables the light signals to be used to reflect the specific position where the scintillation photons are generated inside the crystal 110, i.e., the Depth of Interaction (DOI) capability. After the photoelectric device 120 converts the light signals into the electrical signals, information regarding the position, energy, time, and DOI of the scintillation photon response can be obtained through simple computational processing.

It should be noted that the imaging system operates by sensing signals on the detection assembly to construct a tomographic image of a human body based on positions of annihilation events. The position of the annihilation event is determined based on positions where scintillation photons corresponding to the annihilation event interact in the crystal. The aforementioned detection assembly can accurately locate the position where scintillation photons interact in the crystal, reduce the parallax effect, and improve the spatial resolution capability. This allows the imaging system to pursue high sensitivity without suffering spatial resolution loss due to increased the crystal thickness or the introduction of a longer axial field of view. It also allows the pursuit of high spatial resolution without causing a reduction in the consistency of spatial resolution performance within the FFOV due to reduced crystal size. It balances sensitivity and spatial resolution, thereby improving imaging quality.

It should be noted that in a case where the crystal 110 has the optical partition 111 but no grating structure, the formed detection assembly 100 also possesses DOI capability, but the formed detection assembly 100 may only obtain continuous DOI depth information. Subsequently, it is still necessary to rely on statistics or other conditions to perform layered calibration on the continuous DOI depth information. Near the edge of each DOI layer, there will be a large count of misallocated events caused by resolution broadening. The higher the count of DOI layers, the higher the proportion of misallocated events. The misallocated event may be an event where the imaging system assigns the depth corresponding to a light signal to an incorrect depth.

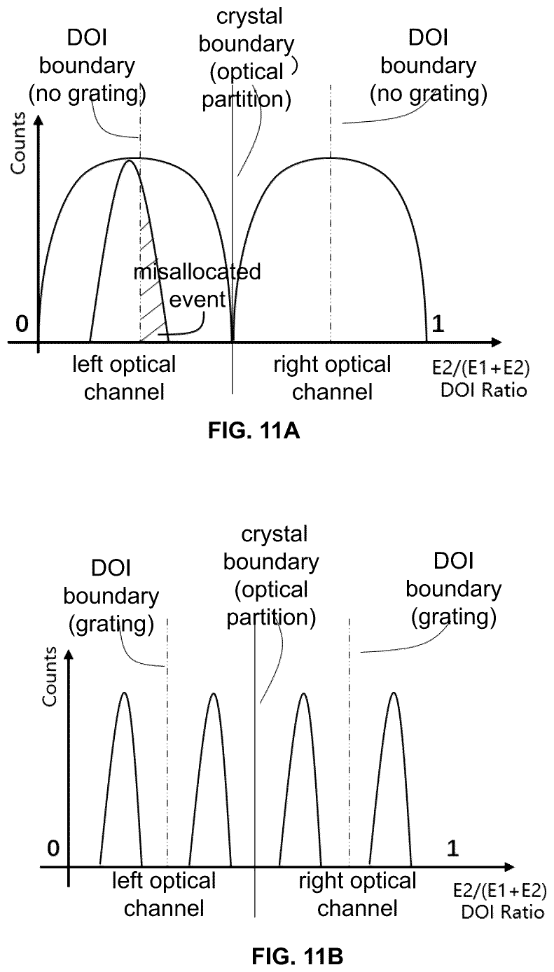

FIG. 11A and FIG. 11B are schematic comparison diagrams illustrating depth of interaction (DOI) capability without and with a grating structure according to some embodiments of the present disclosure. In FIG. 11A and FIG. 11B, the horizontal axis represents a DOI ratio of E2/(E1+E2) , wherein E1 refers to a value of the energy detected by the photoelectric device coupled to the left optical channel (e.g., the optical channel 113 shown in FIG. 1), and E2 refers to a value of the energy detected by the photoelectric device coupled to the right optical channel (e.g., the optical channel 114 shown in FIG. 1). The vertical axis represents a count of scintillation events.

Merely by way of example, as shown in FIG. 11A, in a crystal with the optical partition 111 but without the grating structure, although DOI may bring a certain improvement in the spatial resolution, misallocated events between different DOI layers leads to a deterioration of spatial resolution.

The crystal 110 combining the optical partition 111 and the grating structure 112 can directly obtain discretized DOI depth information, enabling the crystal 110 to inherently possess discrete depth resolution capability. Using the single-end photoelectric device 120 to directly extract the background radiation response or the radioactive source γ characteristic response of the crystal 110 allows for obtaining DOI depth information with high separation. Accurate and reliable DOI depth information can be obtained without the need for a layered calibration process. Simultaneously, it can also effectively improve TOF performance. Merely by way of example, the DOI resolution capability provided by the crystal 110 combining the optical partition 111 and the grating structure 112 is shown in FIG. 11B.

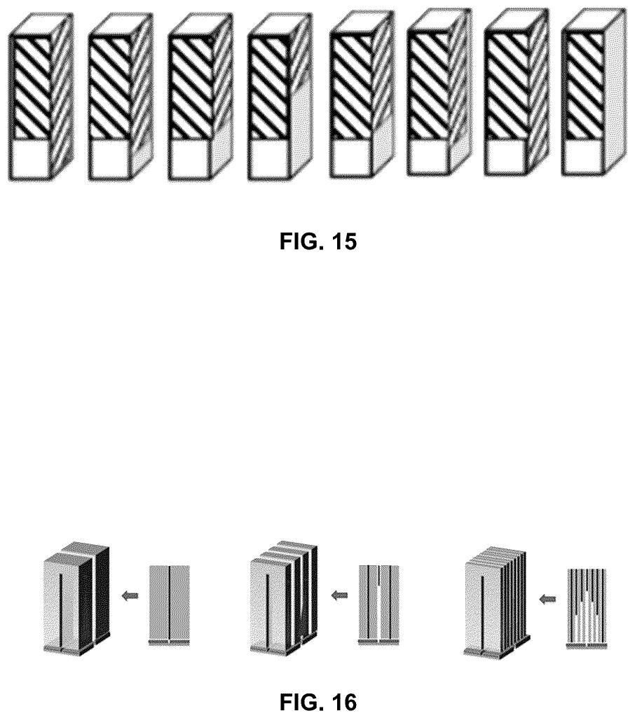

It should be noted that the various scintillation crystals in the crystal array are isolated from each other through an optical isolator. This optical isolator can be a reflective coating applied to the surface of the scintillation crystals, and by setting different coating coverage areas, it can assign different energy weights to scintillation photons generated by different scintillation crystals along the third direction and/or the second direction. As shown in FIG. 15, the surfaces of multiple scintillation crystals arranged along the second direction are provided with reflective coatings (the white areas on the sides) of different coverage areas. As shown in FIG. 16, the more scintillation crystals in the crystal array, the more specifications of different coverage area reflective film coatings (the white areas between the two crystals) will be available, which can be used to achieve more precise optical positioning.

In some embodiments, the optical partitions and the grating structures of the crystals of the detection assembly may be the same.

The present disclosure also provides a method for preparing a crystal for use in a detection assembly.

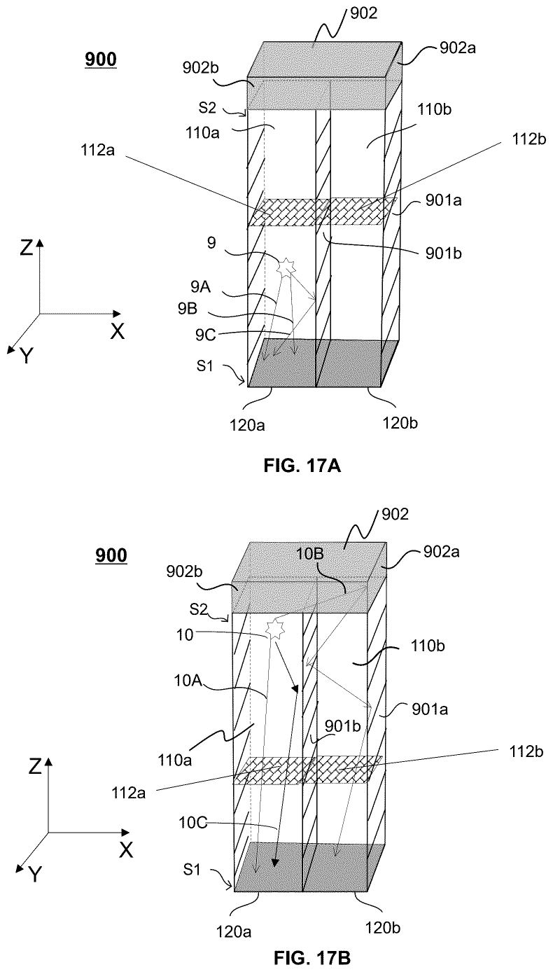

FIG. 17A and FIG. 17B are schematic diagrams illustrating an exemplary structure of a detection assembly according to some embodiments of the present disclosure. Directions X, Y, and, Z shown in FIG. 17A and FIG. 17B correspond to the directions X, Y, and, Z shown in FIG. 1.

In some embodiments, the crystals of the detection assembly may form a plurality of crystal groups along the X direction. Each crystal group may include at least two crystals.

In some embodiments, light sharing between two adjacent (or neighboring) crystals belonging to one crystal group may be allowed, while light sharing between two adjacent crystal groups may be restricted or substantially restricted, in order to facilitate the position determination of a photon gamma interaction. As used herein, two crystals may be regarded as being adjacent to each other or neighboring if there is no other crystal located between them. In some embodiments, two adjacent or neighboring crystals may be spaced apart by a void space, an item other than a crystal (e.g., a film, a coating, a layer of a material different from the material of any crystal element (also referred to as crystal) of the neighboring crystal elements, etc.), or the like, or a combination thereof. Merely by way of example, a space may exist between two neighboring crystal elements, and a portion of the space may be filled with an optical separator (e.g., a second optical separator described elsewhere in the present disclosure) and a portion of the space may be void.

Two crystal groups may be regarded as being adjacent to or neighboring each other if there is no other crystal group located between them. In some embodiments, two adjacent or neighboring crystal groups may be spaced apart by a void space, an item other than a crystal element of a crystal group (e.g., a film, a coating, a layer of a material different from the material of any crystal element of the crystal elements of the neighboring crystal groups, etc.), or the like, or a combination thereof. Merely by way of example, a space may exist between two neighboring crystal groups, and a portion of the space may be filled with an optical separator (e.g., a first optical separator described elsewhere in the present disclosure) and a portion of the space may be void. As another example, a space between two neighboring crystal groups may be substantially completely filled with an optical separator (e.g., a first optical separator described elsewhere in the present disclosure).

As shown in FIGS. 17A and 17B, the crystal group 900 may include a crystal element 110a, a crystal element 110b, and an optical window (not shown in figures). The optical window may allow light transmission between the two crystal elements 110a and 110b of the crystal group 900 so that a photon excited by an photon gamma interaction in a first crystal element of the crystal group 900 can travel into a second crystal element of the crystal group 900 through the second end of the first crystal element, the optical window, and the second end of the second crystal element. For example, a photon excited by a photon gamma interaction in the crystal element 110a may travel into the crystal element 110b through the second end S2 of the crystal element 110a, the optical window, and the second end S2 of the crystal element 110b.

In some embodiments, the optical window may include a plurality of optical separators and a light transmission medium 902. For each of crystal elements of the crystal group 900, an optical separator may be mounted on each side surface of the crystal element facing a neighboring crystal element of the crystal element along the first direction. To control the light transmission between two adjacent crystal elements or crystal groups, a plurality of optical separators may be used in the detection assembly. An optical separator may include a reflective film, a reflective foil, a reflective coating (e.g., a white reflective coating), or any other material that can prevent or substantially prevent light transmission. For example, as illustrated in FIGS. 17A and 17B, a first optical separator 901a may be configured between two adjacent crystal groups. A second optical separator 901b may be configured between two adjacent crystal elements 110a and 110b of the crystal group 900.

The length of the optical separator may be equal to or substantially equal to a length of at least one of the crystal element or the neighboring crystal element. As used herein, a length of an optical separator may refer to its length along the extension direction of a crystal element, i.e., the Z direction. For example, as illustrated in FIGS. 17A and 17B, the optical separator 901a may be mounted on a right side surface of the crystal element 110b facing a neighboring crystal element in a neighboring crystal group (not shown in figures) along the first direction. The length of the optical separators 901a may be equal to the crystal element 110b to prevent a photon in the crystal element 110b from travelling through the right side surface of the crystal element 411 to a neighboring crystal element (not shown in figures). An optical separator 901b may be mounted between a right side surface of the crystal element 110a and a left side surface of the crystal element 110b along the first direction as illustrated in FIGS. 17A and 17B. The length of the optical separators 901b may be equal to the crystal element 110b and/or the crystal element 110a to prevent a light transmission between the crystal elements 110a and 110b through their side surfaces facing each other.

In some embodiments, two neighboring crystal elements of the crystal group 900 may share an optical separator (e.g., a reflective film) located between the two neighboring crystal elements. Alternatively, each of the two neighboring crystal elements may be coated with an optical separator on its side surface facing the other crystal element of the crystal group 900. For example, both the right side surface of the crystal element 110a and the left side surface of the crystal element 110b may be coated with a reflective coating.

The light transmission medium 902 may cover the second ends S2 of the crystal elements 110a and 110b. Each side surface of the light transmission medium 902 that faces the light transmission medium 902 of a neighboring crystal group of the crystal group 900, e.g., side surfaces 902a and 902b may be coated with a light reflective material so as to completely or substantially completely prevent a photon in the crystal group 900 from traveling out of the light transmission medium 902 from the side surfaces of the light transmission medium 902. The light transmission medium 902 may be made of any material substance (e.g., glass) that allows light to pass through. Photons excited by a photon gamma interaction occurred in one crystal element of the crystal group 900 may travel into the light transmission medium 902, be reflected by one of the side surfaces of the light transmission medium 902 for one or more times, and then travel into another crystal element of the crystal group 900. For example, as illustrated in FIG. 9b, a photon 10B generated by photon gamma interaction 10 in the crystal element 110a may travel into the crystal element 110b through the light transmission medium 902.

In some embodiments, as shown in FIGS. 17A and 17B, each of the crystals 110a and 110b may be provided with at least one grating structure. For example, the crystal 110a is provided with a grating structure, the crystal 110b is provided with a grating structure. The grating structure may be similar to the grating structure described above except for certain features including those described below. Taking the grating structure 112a as an example, an area of the grating structure 112a in an X-Y plane may be equal to an area of the crystal 110a in the X-Y plane, i.e., a dimension of the grating structure 112a along the direction X is equal to a dimension of the crystal 110a along the direction X, and a dimension of the grating structure 112a along the direction Y is equal to a dimension of the crystal 110a along the direction Y. The grating structure 112b is similar to the grating structure 112a.

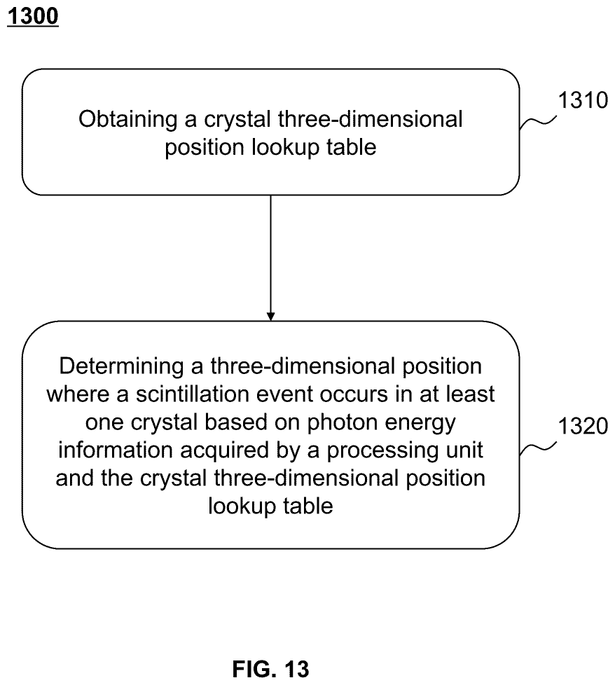

The position of a photon gamma interaction occurred in the crystal group 900 may be determined based on the output information of the photoelectric devices 120a and 120b optically coupled with the crystal group 900. In some embodiments, the position of a photon gamma interaction may be determined based on the energy detected by the photoelectric devices 120a and 120b. For example, as illustrated in FIG. 17A, a photon gamma interaction 9 occurs at a position closer to the first end S1 than the second end of the crystal element 110a. A portion of the photons (e.g., photon 9A, 9B, and 9C) produced by the photon gamma interaction 9 may be directly detected by the photoelectric device 120a optically coupled with the crystal element 110a without passing through the grating structure 112a. As another example, as illustrated in FIG. 17B, the photon gamma interaction 10 occurs at a position closer to the second end S2 than the first end S1 of the crystal element 110a. A portion of the photons generated by the photon gamma interaction 10 (e.g., photons 10A and 10B) may pass through the grating structure 112a and be detected by the photoelectric device 120a. A portion of the photons (e.g., the photon 10B) may travel into the crystal element 110b via the light transmission medium 902, pass through the grating structure 112b, and be detected by the photoelectric device 120b. In some embodiments, the photon gamma interaction position may be determined by performing process 1300 as described in connection with FIG. 13.

Additionally or alternatively, the position of a photon gamma interaction in the crystal group 900 may be determined based on the time when the photons generated by the photon gamma interaction are received the photoelectric devices 120a and 120b. Taking the photon gamma interaction 10 as an example, a time difference between a first time point when the photoelectric device 120a receives a photon (e.g., the photon 10A) and a second time point when the photoelectric device 120b receives a photon (e.g., the photon 10B) may be determined. The DOI of the photon gamma interaction 10 may be estimated based on the time difference and the speed of light. A shorter time difference may indicate that the photon gamma interaction 10 is occurred at a position closer to the second end of the crystal element 110a. In some embodiments, the at least one grating structure provided in the at least one crystal is configured to modulate a first portion of scintillation light to form modulated light; and the at least one photoelectric device disposed at the light emitting surface (the first end) of the at least one crystal is configured to receive the modulated light and a second portion of the scintillation light. The first portion of scintillation light is generated by scintillation events (photon gamma interactions) occurred between (along the first direction) the second end of the at least one crystal and the at least one grating structure. A part of the first portion of scintillation light passes through the light-transmitting region of the at least one grating structure, and the amplitude and/or the phase of the first portion of scintillation light is modulated (e.g., refracted) by the at least one grating structure to form modulated light (e.g., as shown in FIG. 17B). Another part of the first portion of scintillation light is prevented from passing through the at least one grating structure by the light blocking region of the at least one grating structure. The second portion of scintillation light is generated by scintillation events (photon gamma interactions) occurred between (along the first direction) the first end of the at least one crystal and the at least one grating structure. In this case, the second portion of scintillation light is directly received by the at least one photoelectric device without passing through the at least one grating structure (e.g., as shown in FIG. 17A). This embodiment is applied to the crystals in FIGS. 1-17B.

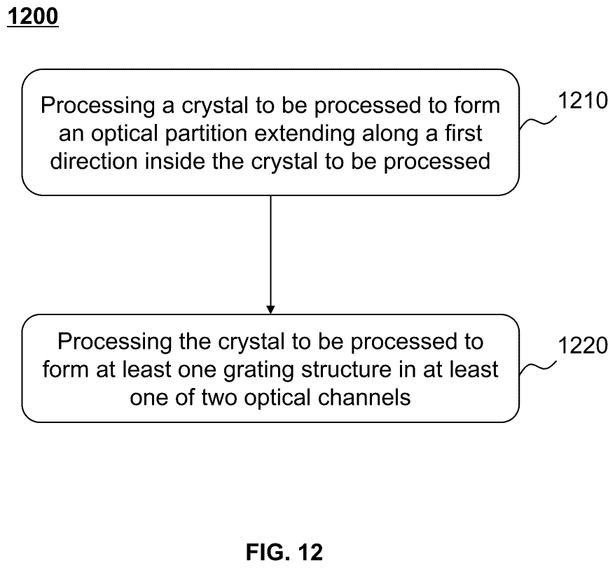

FIG. 12 is an exemplary flowchart illustrating an exemplary method for preparing a crystal according to some embodiments of the present disclosure. In some embodiments, the process 1200 includes the following operations.

In 1210, a crystal to be processed (also referred to as original crystal) may be processed to form an optical partition extending along a first direction inside the crystal to be processed.

In some embodiments, the optical partition forms two optical channels extending along the first direction within the crystal to be processed. The crystal to be processed includes a light incident surface (e.g., a second end) and a light emitting surface (e.g., a first end) oppositely disposed along the first direction. Along the first direction, each of the two optical channels includes a first end and a second end oppositely disposed. The first ends of the two optical channels correspond to the light emitting surface and are optically isolated by the optical partition, and the second ends of the two optical channels correspond to the light incident surface and are optically connected.

In some embodiments, after the crystal is mechanically cut or chemically etched, a gap is formed in the crystal. The optical partition is obtained by filling the formed gap with a light-absorbing material to form a partition layer, or by evaporating a reflective material on a wall surface of the gap to form a reflective layer.

Chemically etching refers to a process of immersing or exposing the crystal to a specific chemical reagent (etchant) to selectively remove crystal material through a chemical reaction.

In practical applications, an etching machine may be used to perform chemical etching at a position on the crystal where a slit needs to be formed, and crystal material at the corresponding position is removed to form the gap. Alternatively, a cutting machine may be used to directly cut the crystal to form the gap.

In some embodiments, an optical partition is formed by modifying or burning the interior of the crystal with a laser to form a modification line or a chain of micropores.

In some embodiments, processing the crystal to be processed to form the optical partition extending along the first direction inside the crystal to be processed may include: preparing a plurality of microstructures in the crystal to be processed by a laser, and chemically etching the plurality of microstructures to form the optical partition in the crystal to be processed.

In some embodiments, an ultrafast laser (e.g., a femtosecond laser) is used to focus a high-energy pulse beam on a starting point of a position inside the crystal where the optical partition is to be formed. After the crystal material at a focal point of the laser absorbs energy, a micro-explosion, melting, or permanent lattice defect occurs, thereby forming a microstructure point. By moving the crystal or the focal point of the laser, the focal point of the laser scans continuously or intermittently along a preset path (e.g., extending from the first end to the second end), finally forming a “guide line” consisting of a large count of densely arranged microstructure points at the position where the optical partition is to be formed. The guide line is more reactive and more fragile in chemical properties than the surrounding untreated crystal material. The position where the optical partition is to be formed may be predetermined.

In some embodiments, the crystal with the guide line is immersed in a specific etchant, and the optical partition is formed by dissolving and removing the crystal material of the microstructure points on the guide line.

In some embodiments of the present disclosure, forming the microstructures in the crystal by the laser processing allows processing to start from any surface or any point of the crystal, without being limited by the shape of the crystal, thereby providing greater design freedom for the detection assembly. Using the chemical etching manner avoids problems such as microcracks and stress damage that may be caused by mechanical cutting, thereby ensuring the original optical performance and mechanical strength of the crystal.

In 1220, the crystal to be processed may be processed to form at least one grating structure in at least one of the two optical channels.

In practical applications, a high-power ultra-short pulse laser beam generated by a laser (or a laser internal engraving machine, etc.) may be focused on a position inside the crystal where a grating structure is to be formed, causing the crystal region at that position to absorb a large amount of energy in a short time and generate a micro-explosion at the focal point, where a large count of micro-explosion points form an internal engraving structure, thereby forming the grating structure inside the crystal.

In some embodiments, the processing sequence of the optical partition and the grating structure is not limited.

In some embodiments, at least one grating structure in each of the two optical channels may be formed by processing the crystal to be processed

In some embodiments, the ultrafast laser (e.g., the femtosecond laser) is used to position the high-energy pulse beam at a starting processing point within a first optical channel. After the crystal material at the focal point of the laser absorbs energy, a micro-explosion or modification occurs, forming a defect point. The defect point may be a light-blocking point or a point where the refractive index is changed.

In some embodiments, under computer control, the focal point of the laser or the crystal is moved according to a preset pattern (e.g., strip-shaped or grid-shaped, etc.) to realize point-by-point scanning of the laser at preset points within the optical channel, thereby forming a first grating layer consisting of a large count of defect points. As needed, a plurality of grating planes may be processed at the same depth, or the plurality of grating planes may be processed at different depths, to constitute a complex grating structure.

In some embodiments, after processing of the first optical channel is completed, the focal point of the laser is repositioned to a starting processing point of a second optical channel. Within the second optical channel, the aforementioned laser scanning process is repeated to process a grating structure that corresponds to the first side or is independently designed. The starting processing point and the preset points may be predetermined.

In some embodiments, to ensure that the count of grating planes in the two optical channels is the same and they correspond in the depth direction, parameters of the ultrafast laser (e.g., energy, speed, and focal length, etc.) need to be consistent.

In some embodiments, the ultrafast laser may also simultaneously process the two optical channels.

In some embodiments of the present disclosure, by performing the same processing operations on both sides, it is ensured that the two optical channels have consistent optical modulation characteristics (e.g., phase, frequency, wavelength, and propagation direction, etc.).

For further description of the above content, refer to FIG. 1 and its related description.

In some embodiments of the present disclosure, the crystal is formed in an inverted “U” shape by the optical partition, which enables single-end readout of the crystal and reduces the complexity and cost of the imaging system. Meanwhile, through the grating structure and dual optical channel design, the imaging system can effectively distinguish signals generated by scintillation photons at different depths, significantly reduce the parallax effect, and improve the consistency of spatial resolution.

The present disclosure also provides a method for determining photon information, which is applied to a detection assembly. The detection assembly includes at least one crystal and a processing unit. The at least one crystal includes a first end and a second end oppositely disposed along a first direction. The processing unit is provided at the first end of the at least one crystal.

An optical partition extending along the first direction is provided within each of the at least one crystal, and the optical partition forms two optical channels extending along the first direction within the crystal along the first direction, each of the two optical channels includes a first end and a second end opposite to each other, the first ends of the two optical channels correspond to the first end of the at least one crystal, and the second ends of the two optical channels correspond to the second end of the at least one crystal and are optically connected. At least one grating structure is provided in at least one of the two optical channels, and the at least one grating structure is configured to differentiate propagation of scintillation photons in the at least one of the two optical channels.

In some embodiments, the method for determining photon information may be performed by a controller of an emission computed tomography system. The emission computed tomography system includes the detection assembly 100.

FIG. 13 is an exemplary flowchart illustrating a method for determining photon information according to some embodiments of the present disclosure. In some embodiments, process 1300 includes the following operations.

In 1310, a crystal three-dimensional position lookup table may be obtained.

The crystal three-dimensional position lookup table is used to describe energy response characteristics detected by the processing unit when a scintillation event occurs in different spatial regions within the at least one crystal. The crystal three-dimensional position lookup table includes a mapping relationship between photon energy information and three-dimensional coordinates of a scintillation event occurring inside the crystal. For a description of the processing unit, refer to FIG. 1 and the related description.

The different spatial regions in the crystal are used to characterize a plurality of physical spaces formed in the crystal by division of the optical partition and the grating structure. Merely by way of example, as shown in FIG. 7, a crystal in a crystal array is divided by an optical partition and a grating structure into 4 physical spaces. Accordingly, the two crystals in FIG. 7 include 8 spatial regions, which are: a left 1 spatial region, a left 2 spatial region, a right 2 spatial region, and a right 1 spatial region of the crystal in the first row; and a left 1 spatial region, a left 2 spatial region, a right 2 spatial region, and a right 1 spatial region of the crystal in the second row.

The photon energy information may be a signal intensity detected by the processing unit. In some embodiments, the processing unit receives a light signal emitted from a light emitting surface of the crystal during a scanning process, converts the light signal into an electrical signal, and obtains the photon energy information after processing the electrical signal through amplification, filtering, or digitization.

In some embodiments, the crystal three-dimensional position lookup table may be stored in a controller.

In some embodiments, the crystal three-dimensional position lookup table may be formed by statistically analyzing a large count of known scintillation event occurrence positions through spontaneous radiation of the crystal or external flood field irradiation. For example, a radioactive source with a known energy (e.g., 68Ge, etc.) or a background radiation of the crystal itself is used to excite scintillation events at a plurality of preset positions within the crystal. Photon energy information collected by the processing unit in each scintillation event is recorded. A mapping relationship between the photon energy information and three-dimensional coordinates of the scintillation event occurring inside the crystal is established through a statistical manner (e.g., a centroid manner or a maximum likelihood manner) to form the crystal three-dimensional position lookup table. The background radiation of the crystal itself may be radiation generated by trace radioactive impurities contained in the crystal material itself.

In 1320, a three-dimensional position where a scintillation event occurs in the at least one crystal may be determined based on photon energy information acquired by the processing unit and the crystal three-dimensional position lookup table.

In some embodiments, the controller matches the photon energy information obtained by the processing unit with data in the crystal three-dimensional position lookup table, and determines the three-dimensional position where the scintillation event occurs inside the at least one crystal through manners such as interpolation, nearest neighbor, or probability matching.

The three-dimensional position may be represented by coordinate information (X, Y, Z) (corresponding to the directions X, Y and Z in FIG. 1).

Merely by way of example, in FIG. 7, the crystal array is coupled to 4 photoelectric devices a-d with a coupling ratio of 1:1, that is, one optical channel is coupled to only one photoelectric device, or in FIG. 5, the crystal array is coupled to 4 photoelectric devices a-d with a coupling ratio of 2:1, that is, two optical channels are coupled to one photoelectric device.

After a scintillation event occurs inside one crystal, the 4 photoelectric devices a-d may obtain energy information Ea, Eb, Ec, and Ed, respectively. The controller may determine (Eb+Ec)/(Ea+Eb+Ec+Ed), which serves as both the X coordinate and the Z coordinate, and determine (Ea+Eb)/(Ea+Eb+Ec+Ed) as the Y coordinate. In practical use, only two coordinate positions (Y, Z) of the scintillation event may be used to look up the table to determine a coordinate position range that includes the coordinate positions (Y, Z), so as to use the spatial region corresponding to the coordinate position range that includes the coordinate positions (Y, Z) as the three-dimensional position where the scintillation event occurs. Taking FIG. 7 as an example, after looking up the table, it is determined that the left 2 spatial region of the crystal in the first row in FIG. 7 is the three-dimensional position where the scintillation event occurs.

The X coordinate characterizes on which side of the inverted “U”-shaped crystal the scintillation event occurs (i.e., position information along the length direction in FIG. 7). The Y coordinate characterizes on which crystal the scintillation event occurs (i.e., position information along the width direction in FIG. 7). The Z coordinate characterizes on which layer of the crystal the scintillation event occurs (i.e., position information along the thickness direction in FIG. 7, which is also depth information).

FIG. 14 shows a measured result of a two-dimensional array discrete DOI of the scintillation crystal array as shown in FIG. 5. For example, as shown in FIG. 14, the horizontal coordinate in FIG. 14 represents the Z coordinate, and the vertical coordinate in FIG. 14 represents the Y coordinate. Each light point area in FIG. 14 represents the location where an annihilation event occurs. A large number of known annihilation event statistics form this figure, from which the coordinate position ranges corresponding to the 32 spatial regions divided by the optical partitions and the grating structures in the crystal array shown in FIG. 5 can be obtained, namely the Z coordinate range and Y coordinate range corresponding to each spatial region, to provide the three-dimensional position for locating the occurrence of the scintillation event.

In some embodiments of the present disclosure, by pre-calibrating a crystal three-dimensional position lookup table, all nonlinear and complex three-dimensional positions are solidified in the lookup table. This enables high-precision positioning of photon energy information through fast table lookup or simple geometric calculations in practical applications.

In addition, some features, structures, or features in the present disclosure of one or more embodiments may be appropriately combined.

In some embodiments, the numbers expressing quantities or properties used to describe and claim certain embodiments of the present disclosure are to be understood as being modified in some instances by the term “about,” “approximate,” or “substantially,”. For example, “about,” “approximate,” or “substantially,” may indicate ±20% variation of the value it describes, unless otherwise stated. Accordingly, in some embodiments, the numerical parameters set forth in the written description and attached claims are approximations that may vary depending upon the desired properties sought to be obtained by a particular embodiment.

In some embodiments, the numerical parameters should be construed in light of the number of reported significant digits and by applying ordinary rounding techniques. Notwithstanding that the numerical ranges and parameters setting forth the broad scope of some embodiments of the present disclosure are approximations, the numerical values set forth in the specific examples are reported as precisely as practicable.

By way of example, should there be any inconsistency or conflict between the description, definition, and/or the use of a term associated with any of the incorporated material and that associated with the present document, the description, definition, and/or the use of the term in the present document shall prevail.

What is claimed is:

1. A detection assembly, comprising:
at least one crystal including a first end and a second end oppositely disposed along a first direction; and
at least one photoelectric device provided at the first end of the at least one crystal; wherein,
an optical partition extending along the first direction is provided within each of the at least one crystal, and the optical partition forms two optical channels extending along the first direction within the crystal;
the two optical channels are optically connected at the second end of the at least one crystal; and
at least one grating structure is provided in at least one of the two optical channels, and the at least one grating structure is configured to differentiate propagation of scintillation light in the at least one of the two optical channels.

2. The detection assembly according to claim 1, wherein the at least one grating structure is distributed along the first direction.

3. The detection assembly according to claim 2, wherein a count of the at least one grating structure is more than one, and each of the two optical channels is provided with at least one of the more than one grating structure.

4. The detection assembly according to claim 3, wherein counts of the grating structures provided in the two optical channels are the same, or height positions, along the first direction, of the grating structures provided in the two optical channels are the same.

5. The detection assembly according to claim 1, wherein one of the at least one grating structure includes a first grating layer and a second grating layer stacked along the first direction, and a light-transmitting region of the first grating layer and a light-transmitting region of the second grating layer partially overlap.

6. The detection assembly according to claim 1, wherein the two optical channels are optically isolated at the first end of the at least one crystal.

7. The detection assembly according to claim 1, wherein the two optical channels are symmetrical with respect to the optical partition.

8. The detection assembly according to claim 1, wherein the optical partition includes at least one of a reflective layer, a gap, or a partition layer.

9. The detection assembly according to claim 1, wherein a count of the at least one photoelectric device is more than one, and the more than one photoelectric device is distributed, along a second direction, on both sides of the optical partition, and the second direction is at a first preset angle with the optical partition.

10. The detection assembly according to claim 9, comprising a plurality of crystals, wherein at least a portion of the plurality of crystals is arranged along the second direction.

11. The detection assembly according to claim 10, wherein each of the more than one photoelectric device covers, along the second direction, two optical channels belonging to different crystals.

12. The detection assembly according to claim 9, comprising a plurality of crystals, wherein at least part of the plurality of crystals is arranged along a third direction, the third direction is at a second preset angle with the first direction, and each of the more than one photoelectric device covers, along the third direction, a plurality of optical channels.

13. A detection assembly, comprising:
at least one crystal configured to receive radiation rays to produce scintillation light, the at least one crystal including a light emitting surface and a light incident surface oppositely disposed along a first direction; and
at least one grating structure provided in the at least one crystal, the at least one grating structure being configured to modulate a first portion of the scintillation light to form modulated light; and
at least one photoelectric device disposed at the light emitting surface of the at least one crystal, at least one photoelectric device being configured to receive the modulated light and a second portion of the scintillation light.

14. The detection assembly according to claim 13, further comprising:
an optical partition that extends along the first direction and is provided within each of the at least one crystal, wherein the optical partition forms two optical channels extending along the first direction within the crystal, and the two optical channels are optically connected at the second end of the at least one crystal.

15. The detection assembly according to claim 14, wherein a count of the at least one grating structure is more than one, and each of the two optical channels is provided with at least one of the more than one grating structure.

16. The detection assembly according to claim 15, wherein counts of the grating structures provided in the two optical channels are the same, or height positions, along the first direction, of the grating structures provided in the two optical channels are the same.

17. The detection assembly according to claim 14, wherein the two optical channels are optically isolated at the first end of the at least one crystal.

18. The detection assembly according to claim 13, wherein one of the at least one grating structure includes a first grating layer and a second grating layer stacked along the first direction, and a light-transmitting region of the first grating layer and a light-transmitting region of the second grating layer partially overlap.

19. The detection assembly according to claim 13, wherein the at least one grating structure is distributed along the first direction.

20. A method for determining photon information, applied to a detection assembly, the detection assembly comprising:
at least one crystal including a first end and a second end oppositely disposed along a first direction; and
at least one photoelectric device provided at the first end of the at least one crystal; wherein,
an optical partition extending along the first direction is provided within each of the at least one crystal, and the optical partition forms two optical channels extending along the first direction with the crystal;
the two optical channels are optically connected at the second end of the at least one crystal; and
at least one grating structure is provided in at least one of the two optical channels, and the at least one grating structure is configured to differentiate propagation of scintillation photons in the at least one of the two optical channels;
the method comprising:
obtaining photon energy information detected by the at least one photoelectric device and a crystal three-dimensional position lookup table;
determining a coordinate position where a scintillation event occurs in the at least one crystal based on the photon energy information; and
determining a three-dimensional position based on the coordinate position and the crystal three-dimensional position lookup table.
